(19) United States
(12) Patent Application Publication
(10) Pub. No.: US 2015/0308496 A1
(43) Pub. Date: Oct. 29, 2015

(54) PROFILE SLIDER, LIFTING COLUMN, AND METHOD FOR ASSEMBLING A LIFTING COLUMN

(71) Applicant: Hans Peter Panzer, Lorrach (DE)

(72) Inventor: Hans Peter Panzer, Lorrach (DE)

(73) Assignee: Aktiebolaget SKF, Goteborg (SE)

(21) Appl. No.: 14/698,344

(22) Filed: Apr. 28, 2015

(30) Foreign Application Priority Data
Apr. 28, 2014 (DE) 102014207930.6

(51) Int. Cl. F16C 29/02; F16C 33/02; F16H 57/00

(52) U.S. Cl. CPC F16C 29/02; F16H 57/00; F16C 33/02; F16C 2300/28

(57) ABSTRACT

A profile slider is attachable to a first profile element for guiding the first profile element linearly relative to a second profile element in a movement direction, and the profile slider includes a guide structure having first and second spaced sliding surfaces and an adjustment structure configured to adjust a distance between the first and second sliding surfaces so that a spacing of the sliding surfaces can be set based on the width of a guide groove of the second profile element. Also a lifting column including the profile slider and a method of assembling the lifting column.

### CROSS-REFERENCE

This application claims priority to German patent application no. 10 2014 207 930.6 filed on Apr. 28, 2014, the contents of which are fully incorporated herein by reference.

### TECHNOLOGICAL FIELD

Exemplary embodiments relate to a profile slider, a lifting column, and a method for assembling a lifting column.

### BACKGROUND

Profile elements are used in a variety of technical fields and may comprise, for example, profile tubes, lifting column elements, and other profiled components. The use of such elements helps make possible, for example, a mechanical aligning, a transporting, or another movement of an object in space. In such applications individual profile elements are thus moved linearly with respect to one another.

Implementing a guiding of the relevant profile elements with respect to one another often presents technical challenges. It is generally desirable to produce movement between profile elements with as little friction as possible, or even a frictionless movement, in a direction of movement. On the other hand, movement of the components with respect to one another in a direction different from the direction of movement should be prevented. An appropriate bearing or bearing assembly allows forces to be exerted on one component by the other component in a direction other than the direction of movement while minimizing or eliminating forces applied in the direction of movement.

One technical possibility for implementing such a bearing or bearing assembly includes at least in part using a sliding bearing.

Profile elements and/or sliding bearings can have manufacturing or other variations and tolerances that should be considered when assembling such components into a larger system or a subassembly. This needs to be done in order to avoid adversely affecting functional security or reliability, or even the comfort or convenience of a user. However, it is also desirable to provide profile elements and systems incorporating such elements that can be manufactured and installed in a simple and cost-effective manner.

A sliding supporting of one profile element with respect to another may be realized using elements referred to herein as “profile sliders,” elements which, for example, may be configured to slide on and/or contact corresponding guide surfaces. If insufficient attention is given to tolerances and clearances, especially in certain applications, systems can fail or function inefficiently or produce undesirable levels of noise. This may be especially problematic when such profile elements are used in lifting columns, for example, lifting columns for machine tools and/or medical equipment. However, similar challenges are by no means limited to the fields of application mentioned.

There is therefore a desire to balance the need for controlling manufacturing-related variations and tolerances with the need to make elements of a profile slider simple and cost-effective to manufacture and assemble.

### SUMMARY

These needs are addressed the embodiments of the present disclosure discussed herein.

A profile slider according to an exemplary embodiment is configured for guiding a first profile element linearly in a direction of movement relative to a second profile element to which it is connected. The profile slider is further configured to contact a guide surface of a guide groove of the second profile element. Moreover, the profile slider is configured to be adjustable based on a distance between first and second guide surfaces of the guide groove.

A lifting column according to an exemplary embodiment comprises a first profile element that has a guide groove with a guide surface and that is movable relative to a second profile element along a movement direction. The lifting column also includes at least one profile slider according to an exemplary embodiment that is attached to the first profile element and disposed such that it is in contact with the guide surface of the guide groove of the second profile element.

A method according to an exemplary embodiment for assembling a lifting column comprises attaching a profile slider to a first profile element and at least partially introducing the profile slider into a guide groove of a second profile element. The second profile element is movable relative to the first profile element in a movement direction. The method also includes adjusting the profile slider in order to bring it into contact with first and second guide surface of the guide groove of the second profile element.

An exemplary embodiment is based on the recognition that a satisfactory balance can be struck between manufacturing and assembly related variations and tolerance and ease of manufacture by using a profile slider that is adjustable based on a distance between two guide surfaces of a guide groove. Such adjustability provides for an easier and faster assembly of large systems such as, for example, a lifting column, that use profile elements according to disclosed embodiments.

The profile slider may have a preferred direction which direction has a predetermined orientation with respect to the movement direction. The predetermined direction of the profile slider can thus, for example, coincide with the movement direction, but can also, for example, form a predetermined angle therewith. Various embodiments of the profile slider may include, for example, a marking or structure that simplifies or makes possible an installation of the profile slider in this orientation. Thus the profile slider can optionally include, for example, an attachment structure that is configured to make the profile slider attachable to the profile element. This can optionally be designed such that the profile slider is attached such that it is fixed rotationally and against other movement relative to the profile element.

The movement direction here can represent a structurally prespecified direction. This can be defined, for example, by the first profile element and/or the second profile element. Thus, for example, the direction of movement can be determined by the course of the guide groove. Despite the word “direction,” in the present case each individual “direction” is not necessarily a direction in the mathematical sense of a vector, but rather a line along which the corresponding movement occurs. Such a line can be straight, but can also be curved. To be distinguished here are directions which actually describe directions along a line, for example, the movement direction. Thus, for example, a first direction can oppose a second direction, but both may extend or be oriented along a line which is also designated as a “direction.”

Optionally a profile slider according to an exemplary embodiment can be configured to be adjustable, without removal, based on a distance between the guide surface and another guide surface after attaching the profile slider to the profile element. In this way it can be possible to simplify even further the manufacture or assembly of a system comprising the two mentioned profile elements. Thus, for example, the profile slider can be accessible, for implementation of the adjustability, via an opening, recess, or another appropriate structure in the first and/or second profile element.

Additionally or alternatively, a profile slider according to an exemplary embodiment can be configured to be substantially dimensionally stable along a direction extending perpendicular to the movement direction when under pressure or load. This may allow for a substantially clearance free/play-free assembly and guiding of the respective profile elements relative to each other. A substantially dimensionally stable implementation can comprise, for example, a dimensionally stable implementation. The profile slider can optionally be dimensionally stable, or substantially dimensionally stable, in an adjusted state of the of the profile slider.

Additionally or alternatively, a profile slider according to an exemplary embodiment can be configured to perform a linear guiding function in a manner that substantially prevents movement of the first profile element relative to the second profile element in a direction perpendicular to the movement direction. This can occur, for example, in the case of pressure or load due to the above-described dimensionally stable design of the profile slider.

Additionally or alternatively, a profile slider according to an exemplary embodiment can be configured to simultaneously be in contact with the guide surface and a further guide surface of the guide groove. As a result it can be possible to reduce the number of components that need to be stocked by using the same profile sliders for guiding along mutually antiparallel directions perpendicular to the movement direction. In turn it can thus be possible to simplify the manufacture or assembly of a corresponding system. Such a profile slider can optionally be configured to substantially simultaneously or simultaneously be in contact with the guide surface and the further guide surface (the first and second guide surfaces).

Optionally such a profile slider according to an exemplary embodiment can include a guide structure and an adjustment structure where the guide structure is configured to be in contact with the first and second guide surfaces. In this case the adjustment structure can be configured to adjust a position of first and second sliding surfaces of the guide structure, surfaces intended to come into contact with two guide surfaces of the guide structure. Using such an implementation it can be possible to make possible an appropriate guiding using constructively simple means.

In a profile slider according to an exemplary embodiment the guide structure can be substantially symmetric with respect to the movement direction. It can thus optionally be possible to simplify an assembly. Alternatively or additionally, it can also be possible to reduce a stress of the attachment of the profile slider on the profile structure. Additionally or alternatively, it can also be possible to achieve a more uniform load or to increase the loadability of the profile slider with respect to its guiding ability. The profile slider can optionally also be configured such that it is substantially symmetric in all adjustment conditions.

A component can, for example, have an n-fold rotational symmetry, where n is an integer greater than or equal to 2. An n-fold rotational symmetry exists if the component in question can be rotated about an axis of rotation or symmetry by (360°/n) and still look the same, i.e. upon a corresponding rotation it is substantially mapped onto itself in the mathematical sense. In contrast, with a completely rotationally symmetric embodiment of a component, with any turn of any angular extent about the axis of rotation or symmetry, the shape of the component remains the same, i.e. is substantially mapped onto itself in the mathematical sense. Both n-fold rotational symmetry and full rotational symmetry are referred to herein as rotational symmetry.

Additionally or alternatively, in a profile slider according to an exemplary embodiment that includes an adjustment structure and a guide structure, these structures can be configured such that the distance between the sliding surface and the further sliding surface (the first and second sliding surfaces) can be increased or decreased. In this way it may be possible to install the profile slider in a substantially force-free state, and then adapt the profile structure and the further profile structure by a later adjustment to the prevailing geometric conditions of the guide groove.

In such a profile slider according to an exemplary embodiment the guide structure can optionally be elastic in order to permit an enlargement of the distance between the sliding surface and the further sliding surface. In this way it can be possible to further simplify a manufacturing of the profile slider by using an appropriate elastic material, since the profile slider can also thus be manufactured with a lower number of individual parts. Additionally or alternatively, a resistance or loadability of the profile slider can be improved by the use of an elastic material in the corresponding regions.

Additionally or alternatively, in a profile slider according to an exemplary embodiment the adjustment structure and the guide structure can each include a gear structure, via which the adjustment structure and the guide structure engage one-into-the-other in order to adjust the distance between the two sliding surfaces. Through such use of a gear structure it may be possible to achieve a defined adjustment of the profile slider. Likewise or alternatively it can be possible to increase a loadability of the profile slider by reducing the risk that the position of the adjustment structure changes relative to the guide structure unintentionally during operation under load. In other words it can be possible to achieve a stable configuration of the profile slider by a type of locking or latching of the adjustment structure with respect to the guide structure.

A lifting column according to an exemplary embodiment can further include a drive unit configured to move one profile element relative to the other profile element. Using such a drive unit it can thus be possible to implement an automated movement.

In such a lifting column according to an exemplary embodiment the drive unit can include a motor configured to rotate a shaft. The drive unit can further comprise a screw drive configured to translate the rotational movement of the motor into a linear movement along the movement direction. The same also optionally applies to a linear movement in a direction opposite the movement direction. The motor can, for example, comprise an electric motor or be an electric motor. The screw drive can comprise, for example, a spindle drive and/or a worm drive.

As used herein, two objects are “adjacent” if no further object of the same type is disposed between them. Objects are “directly adjacent” if they adjoin or abut one another, i.e. they are in contact with one another. Here a “one-piece component” should be understood to mean a component that is manufactured from one continuous piece of material. A “component or structure provided or manufactured one-part” or a “component or structure provided or manufactured integrally with at least one further component or structure” should be understood to mean one which cannot be separated from the at least one further component without destroying or damaging one of the at least two participating components. A one-piece component thus also represents at least one component integrally manufactured or one-part with another structure of the respective component.

A friction-fit contact or a friction-fit connection is present if two objects come into contact with each other in a friction-fit manner such that a force arises between them in the case of a relative movement between them perpendicular to a contact surface, which force makes possible a transmission of a force, a rotational movement, or a torque. A rotational speed difference, i.e., for example, a slippage, can thereby exist. However, in addition to such a friction-fit contact, a friction-fit contact also comprises a friction-fit connection between the respective objects wherein a corresponding rotational speed difference or slippage substantially does not occur.

A “friction-fit” connection results from static friction, a “materially-bonded” connection results from molecular or atomic interactions and forces, and an “interference-fit” connection results from a geometric connection of the respective connection partners. The static friction generally presupposes a normal force component between the two connecting partners.

In a method according to an exemplary embodiment, the above-mentioned method steps can be performed in the specified order, but optionally also in a different order. Thus individual process steps can optionally occur simultaneously, however also at least temporally overlapping one another, provided nothing different results from their description or the technical context.

### BRIEF DESCRIPTION OF THE DRAWINGS

Exemplary embodiments are described and explained in more detail below with reference to the accompanying Figures.

FIG. 1 is an exploded perspective view of a profile slider according to an exemplary embodiment including a guide structure and an adjustment structure.

FIG. 2 is a perspective view of the profile slider of FIG. 1.

FIG. 3 is a plan view of the profile slider of FIGS. 1 and 2.

FIG. 4 is a perspective view of a lifting column including two lifting column elements (profile elements) and a profile slider that guides the two lifting columns linearly with respect to each other.

FIG. 5 is a perspective view of the lifting column of FIG. 4 and illustrates the adjustability of the profile slider.

FIG. 6 is a simplified schematic view of a lifting column according to an exemplary embodiment.

FIG. 7 is a flowchart of a method according to an exemplary embodiment.

### DETAILED DESCRIPTION

In the following description of the accompanying Figures, like reference numbers refer to like or comparable components. Furthermore, summarizing reference numbers are used for components and objects that appear multiple times in an exemplary embodiment or in an illustration, but that are described together in terms of one or more common features. Components or objects that are described with the same or summarizing reference numbers can be embodied identically, but also optionally differently, in terms of individual, multiple, or all features, their dimensions, for example, as long as the description does not explicitly or implicitly indicate otherwise.

As was briefly mentioned above, in many technical fields profile elements are used for supporting, positioning, or moving components, objects, animals, or people. Profile elements can be, for example, profile tubes, lifting column elements, or other profiled components. These may have a largest dimension in a main extension direction. Along this main extension direction the profile elements can have a uniformly designed profile or an at least sectionally uniformly designed profiling.

Depending on the specific implementation, the profile may include a guide groove that helps make it possible to guide one profile element with respect to another. Depending on the specific implementation a sliding bearing can be used.

Such a sliding bearing can be implemented using one or more profile sliders. These can be used for guiding telescopic profile tubes or other lifting column elements, to name only two examples. The respective profile elements are manufactured to meet certain tolerances, and thus may vary somewhat with respect to their design. If these variations are not taken into account in assembly and possibly compensated for, they can result in reliability problems or problems with respect to the functionality of a system which comprises the mentioned profile elements. Alternatively or additionally, parts that do not fit as intended may created unwanted noise during operation. Even if the variations do not adversely affect mechanical operation, the noise may be unpleasant for users or could be misinterpreted as indicative of an impending failure.

Conventionally, different profile sliders are thus provided with different widths, and a proper profile slider must be selected based on the actual dimensions of the profile elements with which they are used.

As the following discussion shall show, using an adjustable profile slider according to an exemplary embodiment allows for a better fit between profile elements or even, possibly, for a clearance/play-free installation. Depending on the specific implementation of such an adjustable profile slider, it can compensate for a certain range of a tolerances between the guide surfaces, which are also referred to as sliding surfaces, in the profile elements and even for an angular displacement of a profile groove. In this way play between elements of a profiled element set, i.e., a profile tube set, can be avoided without the need to provide a plurality of different sized profile sliders. Such a profile slider can be manufactured from two different plastic parts, as the following description shall show, and this may reduce the number of individual widths required in the individual sliders.

Although in the following description the focus is on the use of adjustable profile sliders for lifting columns, i.e., lifting columns including an integrated sliding system, exemplary embodiments of a profile slider can also be used in other systems, subassemblies, and components in which a linear movement is to be guided between two profile elements. This movement can be caused, for example, using an actuator system, which is also referred to as a drive unit.

In other words, even though in the following discussion the focus is on lifting columns, an adjustable profile slider can be used in a wide variety of different systems.

A profile slider can thus be used for a linear guiding. It should be noted here that a linear guiding can comprise movements that are not perfectly linear, if, for example, the relevant structures for guiding are curved or have other appropriate contours. However, profile sliders can also be used for supporting rotational movements. Accordingly bearings can be implemented, for example, as linear bearings or also as bearings for guiding rotational movements.

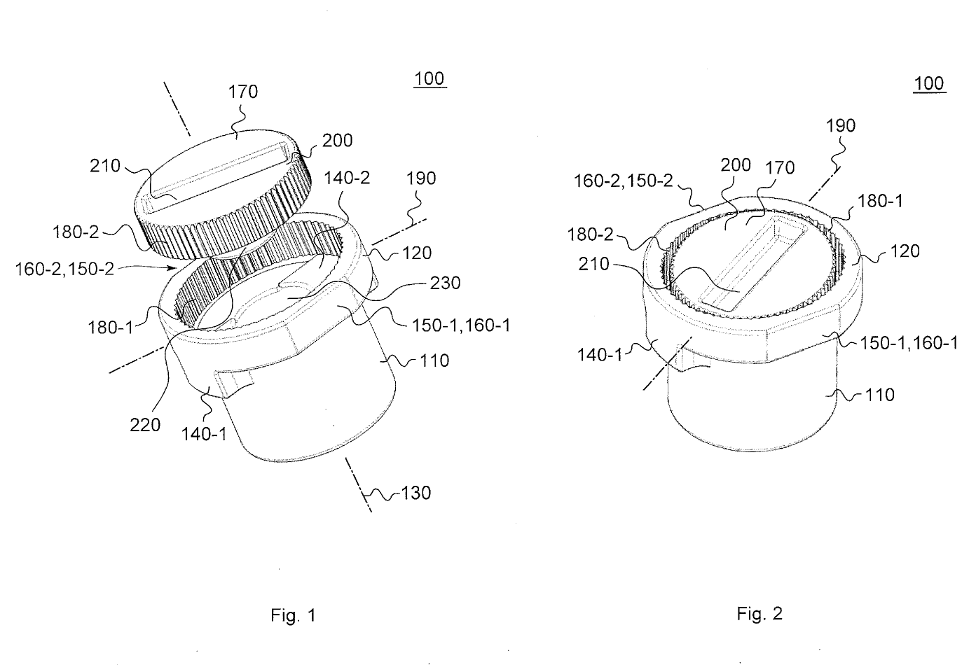

FIG. 1 shows a perspective exploded view of a profile slider 100 according an exemplary embodiment configured for the linear guiding of one profile element relative to another profile element in a movement direction. For ease of illustration, however, the movement direction is not depicted in FIG. 1. The profile slider 100 is capable of being attached to the profile element, and the profile slider 100 includes an attachment structure 110. The attachment structure 110 has a hollow cylindrical outer contour, via which the profile slider 100 can be inserted into a corresponding bore of the profile element not shown in FIG. 1 and attached thereto.

More specifically, the attachment structure 110 is configured as a hollow cylinder, but it can also be configured only sectionally in the shape of a hollow cylinder or even as a filled or solid cylinder. Of course other examples of profile sliders 100 can have differently shaped attachment structures 110 using which the respective profile slider 100 can be attached in an associated profile element. Thus, in principle, the attachment structure 110 can have any shape, i.e., for example, a polygonal outer contour, or a rectangular, square, triangular, or even an irregularly formed or asymmetric outer contour. The same can also apply for an inner contour in the case of a hollow body or other components of the surface of the attachment structure 110.

The profile slider 100 also includes a guide structure 120 that is substantially ring-shaped and is offset from a main axis 130 of the attachment structure 110 such that in the previous example the guide structure 120 has a two-fold symmetry with respect to the main axis 130.

The guide structure 120 is connected to the attachment structure 110 via two diametrically opposing connecting sections 140-1 and 140-2. The connecting structures 140 protrude radially beyond the outer surface of the attachment structure 110 and thus break the complete rotational symmetry of the attachment structure 110 shown in FIG. 1.

The guide structure 120 has a substantially cylindrical outer contour, which, however, is interrupted by two flattened regions 150-1, 150-2. Thus the guide structure 120 is narrower (in a direction perpendicular to the main axis 130) in the area of the flattened regions 150 than outside the flattened regions 150. The flattened regions 150 form two sliding surfaces 160-1, 160-2 that can be brought into contact with corresponding guide surfaces of a guide groove of a profile element. An adjustment structure 170 can be used to properly position the sliding surfaces 160 and will be described in more detail below.

The guide structure 120 has a gear structure 180-1, and the adjustment structure 170 has a gear structure 180-2, and the gear structures 180 are designed precisely such that they can engage into each other. As discussed below, these gear structure help make it possible to adjust a distance between the sliding surfaces 160.

In other words, the guide structure 120 includes the gear structure 180-1 on its inner contour, which gear structure 180-1 may also be referred to as “the gear,” and the guide structure 120 forms precisely the outer part of the profile slider 100.

The adjustment structure 170 is correspondingly also referred to as the inner part and also includes the above-mentioned gear or gear structure 180-2, which, however, is disposed on an outer contour of the adjustment structure 170. Here the outer contour of the adjustment structure 170 is non-circular or out-of-round, that is, it has a greater extension in a first direction perpendicular to the main axis 130 that it does in a second direction perpendicular to the main axis 130 and perpendicular to the first direction. In other words, the adjustment structure 170 may have an oval, elliptical, or other non-circular outer contour.

In still other words, due to its non-circular shape the adjustment structure 170 has an extension, a radius, or a diameter along a direction perpendicular to the main axis 130 that is greater than that perpendicular to the two above-mentioned directions.

Rotating the, e.g., elliptical adjustment structure 170 inside the essentially circular inside of the guide structure 120 tends to deform the guide structure along the direction of the major axis of the elliptical adjustment structure 170. When the adjustment structure 170 is rotated so that the major axis of the ellipse is moved to the region of the parts of the gear structure 180-1 which inwardly oppose the sliding surface 160, a force is exerted on the guide structure 120. This force can deform the guide structure 120 and affect a distance between the sliding surfaces 160 of the guide structure in order to match a distance between guide surfaces of a guide groove in which the profile slider is mounted.

To facilitate such a deformation, the guide structure 120 may, optionally, be manufactured from an elastic material, for example an elastic plastic. The connection sections 140 and/or the attachment structure 110 may be made from this same material. In other words, in the example shown in FIG. 1 of a profile slider 100, the attachment structure 110, the guide structure, and the connecting structure 140 are manufactured as one piece. Of course in other examples of a corresponding profile slider 100, the guide structure 120, the connecting sections 140, and the attachment structure 110 can also be manufactured from different materials, which are provided one-part, for example.

The above-described design of the profile slider 100 allows the distance between sliding surfaces 160 of the guide structure 120 to be increased from an initial setting at which the sliding surfaces 160 have a smallest separation to a greater separation. The profile slider 100 can be symmetric with respect to a movement direction 190, a movement direction that extends perpendicular to the main axis 130 and that is substantially parallel to both sliding surfaces 160 in the example of a profile slider 100 shown in FIG. 1. In this way it can optionally be possible to reduce occurring shear forces and other forces and torques harmful to the profile slider 100 and thus optionally increase the service life of the profile slider 100.

If the adjustment structure 170 also has a symmetric design with respect to an axis of symmetry perpendicular to the main axis 130 (which, due to the rotatability of the adjustment structure 170 need not coincide with the movement direction 190 of the profile slider 100), then the above-described symmetry can also optionally be realized in all adjustment conditions/settings of the profile slider 100, i.e. in all angular positions of the adjustment structure 170 with respect to the guide structure 120.

The adjustment structure 170 also includes an opening 210 in a head region 200 (the head region 200 also includes the gear structure 180-2 on its outer flank or outer contour). The opening 210 is elongated and configured for receiving a tool such as a screwdriver head. The extension direction of the opening 210 can be associated with or correspond to the largest extension of the non-circular outer contour of the adjustment structure 170 in order to provide during assembly an indication of the degree of the distance enlargement between the sliding surfaces 160. In this way it can thus be possible to adjust the profile slider 100, without removing it, to the distance of the guide surfaces (not shown in FIG. 1) after attaching the profile slider 100 to the respective profile element.

Of course, in other examples of a profile slider 100 another design of the opening 210 and another design of a corresponding structure of the adjustment structure can be effected, via which the adjustment structure 170 is rotatable with respect to the guide structure 120 in the assembled state to make the profile slider 100 adjustable.

The adjustment structure 170 also includes an optional centering structure 220, which in the example shown is connected one-piece or one-part to the head region 200. The centering structure 220 is configured as a cylindrical extension that extends along the main axis 130 into a central opening 230 of the attachment structure 110. Lateral movement of the adjustment structure 170 relative to the guide structure 120 can thus optionally be prevented by the centering structure 220 and the central opening 230. In this way the symmetric force development and the symmetric design of the guide structure 120 with its sliding surfaces 160 can be improved.

FIG. 2 shows a perspective view of the profile slider 100 with the adjustment structure 170 introduced into the guide structure 120 such that the gear structures 180 are in mutual engagement with each other.

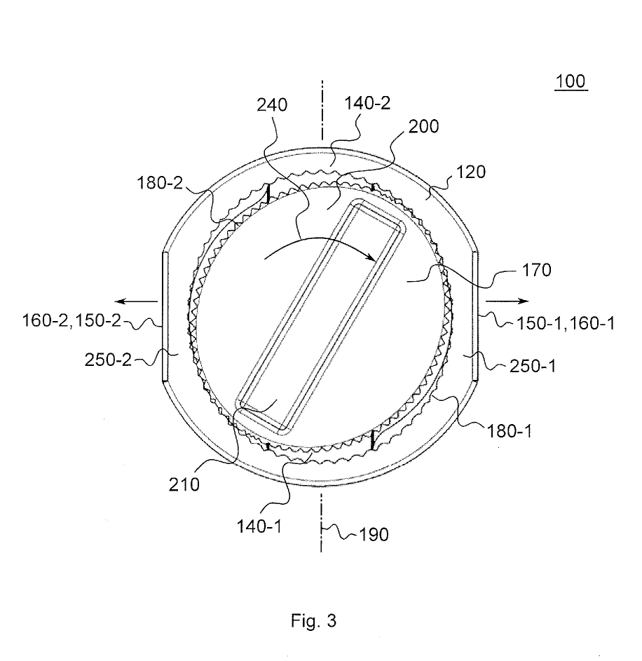

FIG. 3 makes clear that by rotating the inner part, that is, the adjustment structure 170, in the rotation direction indicated by arrow 240, the outer part, that is, the guide structure 120, can be expanded in the region of the two sliding surfaces 160. In this way it can be possible to adapt the guide structure 120 to prevailing tolerances of the profile slider and to tolerances of a corresponding guide groove of an associated profile element or profile tube. As has already been described, for this purpose lateral sections 250-1, 250-2, on which the flattened regions 150 and the sliding surfaces 160 are formed, are flexible or elastic, so that a flexible lateral contour is present in those regions.

This described design allows a profile slider 100 to be substantially dimensionally stable along a direction extending perpendicular to the movement direction 190 under an applied load. On the one hand the lateral sections 250 or the sliding surfaces 160 support one another via the adjustment structure 170 on the guide surfaces. On the other hand a force-supporting can also be effected via the centering structure 220 and the central opening 230 and thus via the attachment structure 110 and the profile element. The profile slider 100 can thus effect a linear guiding of the relevant profile elements with respect to each other while substantially avoiding relative movement perpendicular to the movement direction 190.

The above-described slider thus comprises two, for example, elliptical plastic parts which in an unassembled state are smaller than the guide groove, also referred to as sliding groove, of the profile elements (profile tubes). After installation, the adjustment structure 170, also referred to as the inner part, can be rotated via a bore with respect to the guide structure 120, also referred to as outer part, so that width of the guide structure 120 in the region of the sliding surfaces 160 becomes wider or such that the distance between the sliding surfaces 160 increases and thus be adjusted to the specified profile groove width.

Of course in other examples of a profile slider 100 the constructive design features can be chosen differently. Thus, for example, the number of attachment sections 140, their geometric design, arrangement, and other parameters can be changed. Likewise an implementation of the gear structure 180 can optionally be omitted, or, alternately implemented as a single direction ratchet. A solution can also be implemented in which the adjustment structure 170 is not centered in the interior of the guide structure 120. Thus, for example, asymmetrically implemented solutions, wherein an adjustment is effected, for example, by a shifting and not by a rotating of the adjustment structure 170, can also be implemented.

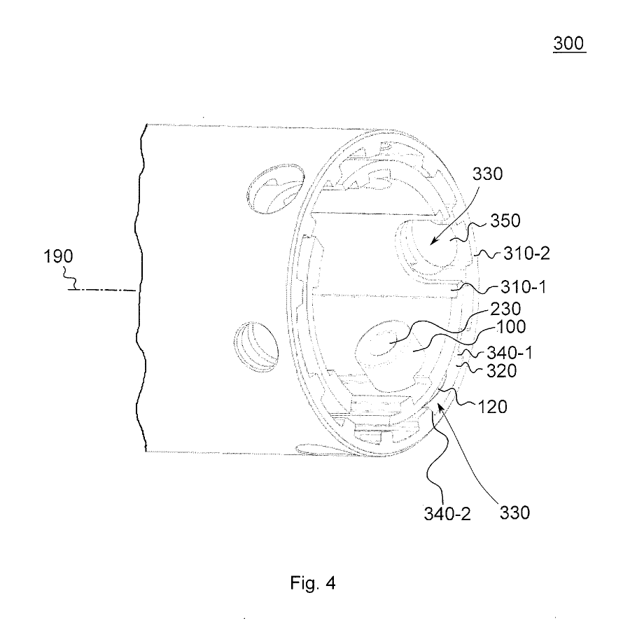

FIG. 4 shows a perspective view of a detail of a lifting column 300 having a first profile element 310-1 and a second profile element 310-2. The second profile element 310-2 includes a guide groove 320 that makes possible movement of the two profile elements 310 with respect to each other in a direction perpendicular to the movement direction 190. In the design shown in FIG. 4 the profile slider 100 shown and described above is attached in an attachment opening 330. This attachment opening 330 is now precisely so disposed and oriented that the profile slider 100 is in contact with the guide surfaces 340-1, 340-2 of the second profile element 310-2. In the adjusted state of the profile slider 100, for example, a substantially play-free guiding of the two profile elements 310 relative to each other along the movement direction 190 can thereby be implemented.

Although FIG. 4 only shows a single profile slider 100, of course in other lifting columns 300 more than one profile slider, for example, different types but also identical types and designs, can be used.

FIG. 4 also shows an adjustment opening 350 in the second profile element 310-2, which allows access to the adjustment structure 170 when the two profile elements 310 are in a defined relationship with respect to each other, in order to thus adjust the profile slider 100 or sliders 100 when the profile elements are in the assembled or attached state.

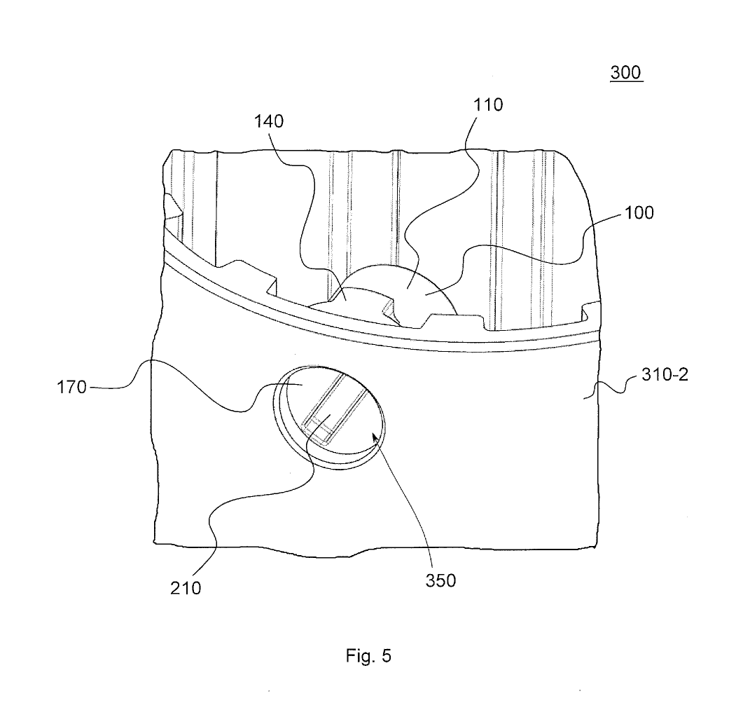

FIG. 5 shows a perspective view of the lifting column 300 of FIG. 4, wherein for simplification of illustration, only the second profile element 310-2 is shown. Thus FIG. 4 shows that the adjustment opening 350 provides access to the profile slider, and in particular to the adjustment structure 170 with the opening 210, an opening configured in this case for a screwdriver or a similar tool. The profile element 310-1 may also be referred to as the inner profile and the second profile element 310-2 may be referred to as the outer profile. The guide groove 320 may also be referred to as the profile groove of the outer profile. FIG. 5 thus shows a possibility of how an adjustability of the profile slider 100 can be implemented, even in the assembled state, using the adjustment opening 350.

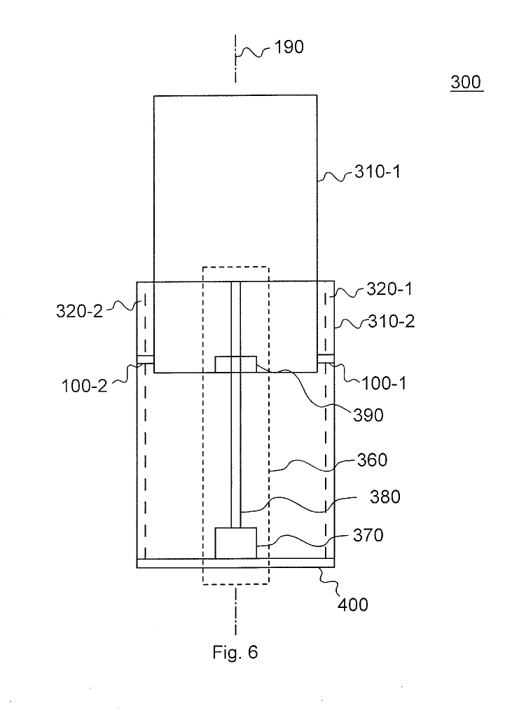

FIG. 6 is a schematic view of a lifting column 300 that includes an inwardly disposed or first profile element 310-1 and a second or further profile element 310-2 which is disposed radially outside the profile element 310-1 and accordingly at least partially surrounds it. Of course in other examples of a lifting column 300 the profile elements 310-1, 310-2 can also be exchanged with respect to their being disposed inward or outward.

The second profile element 310-2 in turn includes guide grooves 320-1, 320-2, which extend along the movement direction 190, along which the two profile elements 310 are also movable with respect to each other.

The lifting column 300 further comprises one or more profile sliders 100, such as those described above. The lifting column 300 in FIG. 6, comprises at least two profile sliders 100-1, 100-2, which can be configured, for example, identical, but also optionally different from each other. The profile sliders 100 are attached to or onto the first profile element 310-1 via corresponding structures in the profile element 310-1 and disposed such that they are in contact with the guide surfaces 340 of the second profile element 310-2, which guide surfaces 340 are formed by the guide grooves 320.

In order to make the lifting column 300 move, it further includes an optional drive unit 360 that is capable of moving the first profile element 310-1 with respect to the second profile element 310-2 along the movement direction 190. For thus purpose the drive unit 360 includes a motor 370. The motor 370 illustrated here is an electric motor, but the drive unit could also comprise a pneumatic, hydraulic or other drive that is configured to rotate a shaft 380. The drive unit 360 further includes a screw drive 390 that is capable of translating the rotational movement of the shaft 380 into a linear movement along the movement direction 190. The screw drive 390 can comprise, for example, a spindle drive or a worm drive. Of course, however, other constructions of a drive unit 360 can also be used.

As described above, in this context the use of an adjustable profile slider can make possible a simpler assembly and a reduction of parts, so that the need to use profile sliders of different widths can be avoided. These profile sliders are optionally implemented in a rigid construction so that a rotational movement imparted by the motor 370 can also be delivered via a base plate 400 without the profile element 310-1 in the embodiment shown here receiving a significant, play-related rotational movement. The base plate 400 can serve, for example, for receiving the motor 370, but also for mounting the second profile element 310-2.

Here of course in other examples of lifting columns 300 other constructive designs can be chosen.

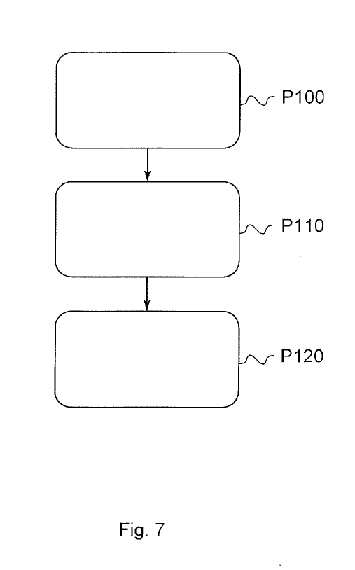

Finally FIG. 7 is a flowchart illustrating a method for installing a lifting column. In a process P100 a profile slider 100 is first attached to a profile element 310-1. The method further comprises, in a process P110, at least partially introducing the profile slider 100 into a guide groove of a second profile element that is movable along the movement direction 190 relative to the first profile element 310-1. In a process P120 the profile slider 100 can then be adjusted in order to bring it into contact with the guide surface of the guide groove 320 of the second profile element 310-2 and to adjust the profile slider 100 to a distance between the two guide surfaces of the guide groove 320.

In an exemplary embodiment of a method, the above-mentioned method steps can be performed in the specified order, but optionally also in a different order. Thus individual process steps can optionally occur simultaneously, however also at least temporally overlapping one another, provided nothing different results from their description or the technical context.

By using an exemplary embodiment, an appropriate balance can be struck between allowing for manufacturing-related variations and keeping manufacture and assembly as simple and efficient as reasonably possible.

The features disclosed in the foregoing description, the following claims, and the accompanying Figures can be meaningful and can be implemented both individually as well as in any combination for the realization of an exemplary embodiment in its various embodiments.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved profile sliders and associated assemblies of profile elements.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

100 Profile slider
110 Attachment structure
120 Guide structure
130 Main axis
140 Connecting section
150 Flattened region
160 Sliding surface
170 Adjustment structure
180 Gear structure
190 Movement direction
200 Head area
210 Opening
220 Centering structure
230 Centered opening
240 Rotation
250 Lateral section
300 Lifting column
310 Profile element
320 Guide groove
330 Attachment opening
340 Guide surface
350 Adjustment opening
360 Drive unit
370 Motor
380 Shaft
390 Screw drive
400 Base plate

What is claimed is:

1. A profile slider for guiding a first profile element linearly relative to a second profile element in a movement direction,
wherein the profile slider is configured to be attached to the first profile element and to contact a first guide surface of a guide groove of the second profile element, and
wherein the profile slider is configured to be adjustable based on a distance between the first guide surface of the guide groove and a second guide surface of the guide groove.

2. The profile slider according to claim 1, wherein the profile slider is configured to be adjustable without removal from the first profile element.

3. The profile slider according to claim 1, wherein the profile slider is configured to be substantially dimensionally stable under load along a direction perpendicular to the movement direction.

4. The profile slider according to claim 1, wherein the profile slider is configured to simultaneously be in contact with the first guide surface and the second guide surface of the guide groove.

5. The profile slider according to claim 4, wherein the profile slider includes a guide structure and an adjustment structure, the guide structure being configured to be in contact with the first and second guide surfaces, and the adjustment structure being configured to make adjustable a position of a first sliding surface of the guide structure and a second sliding surface of the guide structure, the first sliding surface being configured to make contact with the first guide surface, and the second sliding surface being configured to make contact with the second guide surface.

6. The profile slider according to claim 5, wherein the guide structure is symmetric with respect to the movement direction.

7. The profile slider according to claim 5, wherein the adjustment structure and the guide structure are configured to increase the distance between the first and second sliding surfaces starting from an initial setting at which the first and second sliding surfaces have a smallest-possible separation.

8. The profile slider according to claim 5, wherein the adjustment structure and the guide structure each include a gear structure, via which the adjustment structure and the guide structure engage one-into-the-other in order to make the distance from the sliding surface to the further sliding surface adjustable.

9. A lifting column comprising:
a first profile element;
a second profile element including a guide groove having a guide surface, the second profile element being movable relative to the first profile element in the movement direction; and
at least one profile slider according to claim 1 attached to the first profile element and in contact with the guide surface of the guide groove of the second profile element.

10. The lifting column according to claim 9, wherein the profile slider includes a guide structure, the guide structure having a first sliding surface and a second sliding surface, and an adjustment structure configured to adjust a spacing between the first sliding surface and the second sliding surface.

11. The lifting column according to claim 9, wherein the guide structure includes inwardly directed gear teeth and the adjustment structure includes outwardly directed gear teeth, at least some of the outwardly directed gear teeth meshing with at least some of the inwardly directed gear teeth.

12. A method for assembling a lifting column, comprising:
attaching a profile slider to a first profile element, the profile slider having a first sliding surface and a second sliding surface;
at least partially introducing the profile slider into a guide groove of a second profile element, the guide groove having a first guide surface and a second spaced guide surface, the second profile element being movable in a movement direction relative to the first profile element; and
shifting the profile slider from a first configuration in which the first sliding surface is in contact with the first guide surface and the second sliding surface is spaced from the second guide surface to a second configuration with the first sliding surface in contact with the first guide surface and the second sliding surface in contact with the second guide surface.

13. The profile slider according to claim 1, comprising a guide structure including first and second spaced sliding surfaces and an adjustment structure configured to adjust a distance between the first and second spaced sliding surfaces.

14. The profile slider according to claim 13, wherein the profile slider comprises a shank portion and a head having an open interior, the first and second sliding surfaces being located on an exterior of the head, and wherein the adjustment structure comprises a body having a long dimension perpendicular to a short dimension rotatably mounted in the open interior.

15. The profile slider according to claim 15, wherein the open interior includes inwardly directed gear teeth and wherein the body includes exteriorly directed gear teeth, at least some of the gear teeth of the body engaging at least some of the gear teeth of the open interior.

16. A profile slider attachable to a first profile element for guiding the first profile element linearly relative to a second profile element in a movement direction, the profile slider comprising:
a guide structure comprising first and second spaced sliding surfaces; and
an adjustment structure configured to adjust a distance between the first and second spaced sliding surfaces.

17. The profile slider according to claim 16, wherein the profile slider comprises a shank portion and a head having an open interior, the first and second sliding surfaces being located on an exterior of the head, and wherein the adjustment structure comprises a body having a long dimension perpendicular to a short dimension rotatably mounted in the open interior.

18. The profile slider according to claim 17, wherein the open interior includes inwardly directed gear teeth and wherein the body includes exteriorly directed gear teeth, at least some of the gear teeth of the body engaging at least some of the gear teeth of the open interior.
